(19) United States
(12) Patent Application Publication
(10) Pub. No.: US 2024/0430737 A1
(43) Pub. Date: Dec. 26, 2024

(54) TRAFFIC TYPE BASED QOE MAINTENANCE FOR MOBILE DEVICES

(71) Applicant: Samsung Electronics Co., Ltd., Suwon-si (KR)

(72) Inventors: Anum Ali, Frisco, TX (US); Vutha Va, Plano, TX (US); Yuqiang Heng, Plano, TX (US); Priyabrata Parida, Dallas, TX (US); Boon Loong Ng, Plano, TX (US)

(21) Appl. No.: 18/539,144

(22) Filed: Dec. 13, 2023

Related U.S. Application Data
(60) Provisional application No. 63/522,956, filed on Jun. 23, 2023.

(51) Int. Cl. H04W 28/02

(52) U.S. Cl. CPC H04W 28/0268

(57) ABSTRACT

Apparatuses and methods for traffic type based quality of experience (QoE) maintenance for mobile devices. A user equipment (UE) includes a transceiver. The transceiver is configured to receive and transmit traffic over a link with a wireless network. The UE further includes a processor operably coupled to the transceiver. The processor is configured to classify the traffic into at least one of real time (RT) traffic or non-real-time (NRT) traffic, generate a link deterioration prediction, select, based on the link deterioration prediction and the traffic class, a QoE maintenance action, and perform the QoE maintenance action.

### CROSS-REFERENCE TO RELATED APPLICATION(S) AND CLAIM OF PRIORITY

This application claims priority under 35 U.S.C. § 119(e) to U.S. Provisional Patent Application No. 63/522,956 filed on Jun. 23, 2023. The above-identified provisional patent application is hereby incorporated by reference in its entirety.

### TECHNICAL FIELD

This disclosure relates generally to wireless networks. More specifically, this disclosure relates to apparatuses and methods for traffic type based QoE maintenance for mobile devices.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for traffic type based QoE maintenance for mobile devices.

In one embodiment, a user equipment (UE) is provided. The UE includes a transceiver. The transceiver is configured to receive and transmit traffic over a link with a wireless network. The UE further includes a processor operably coupled to the transceiver. The processor is configured to classify the traffic into at least one of real time (RT) traffic or non-real-time (NRT) traffic, generate a link deterioration prediction, select, based on the link deterioration prediction and the traffic class, a quality of experience (QoE) maintenance action, and perform the QoE maintenance action.

In another embodiment, a method of operating a UE is provided. The method includes receiving and transmitting traffic over a link with a wireless network, classifying the traffic into at least one of RT traffic or NRT traffic, selecting, based on the link deterioration prediction and the traffic class, QoE maintenance action, and performing the QoE maintenance action.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example of a QoE maintenance procedure according to various embodiments of this disclosure;

FIG. 5 illustrates an example of traffic class specific action selection according to various embodiments of this disclosure;

FIG. 6 illustrates an example procedure for selective activation of QoE maintenance according to various embodiments of this disclosure;

FIG. 7 illustrates an example procedure for link deterioration prediction according to various embodiments of this disclosure;

FIG. 8 illustrates an example procedure for link deterioration prediction according to various embodiments of this disclosure;

FIG. 9 illustrates an example of traffic class specific action selection according to various embodiments of this disclosure;

FIG. 10 illustrates an example of traffic class specific action selection according to various embodiments of this disclosure;

FIG. 11 illustrates an example of traffic class specific action selection according to various embodiments of this disclosure;

FIG. 12 illustrates an example of traffic class specific action selection according to various embodiments of this disclosure;

FIG. 13 illustrates an example of traffic class specific action selection according to various embodiments of this disclosure;

FIG. 14 illustrates an example procedure for proactive QoE maintenance according to various embodiments of this disclosure; and

FIG. 15 illustrates a method for traffic type based QoE maintenance according to embodiments of the present disclosure.

### DETAILED DESCRIPTION

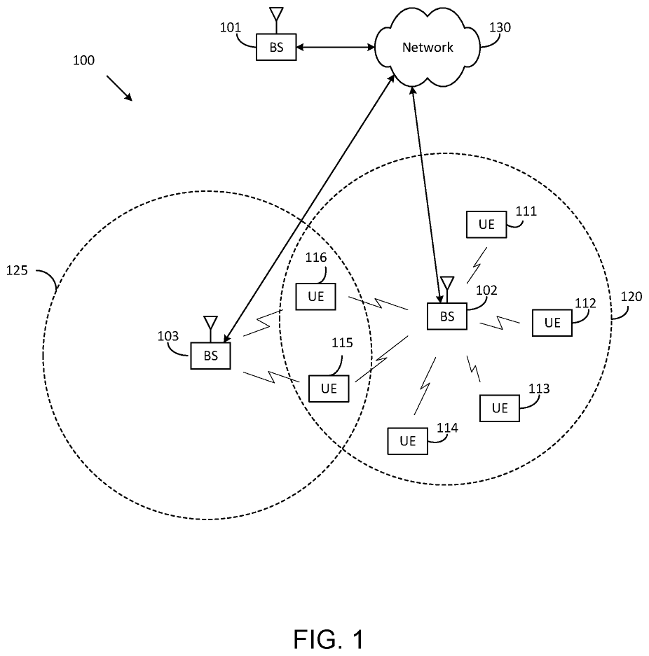

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a traffic type based QoE maintenance for mobile devices. In certain embodiments, one or more of the gNBs 101-103 includes circuitry, programing, or a combination thereof, to support a traffic type based QoE maintenance for mobile devices in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

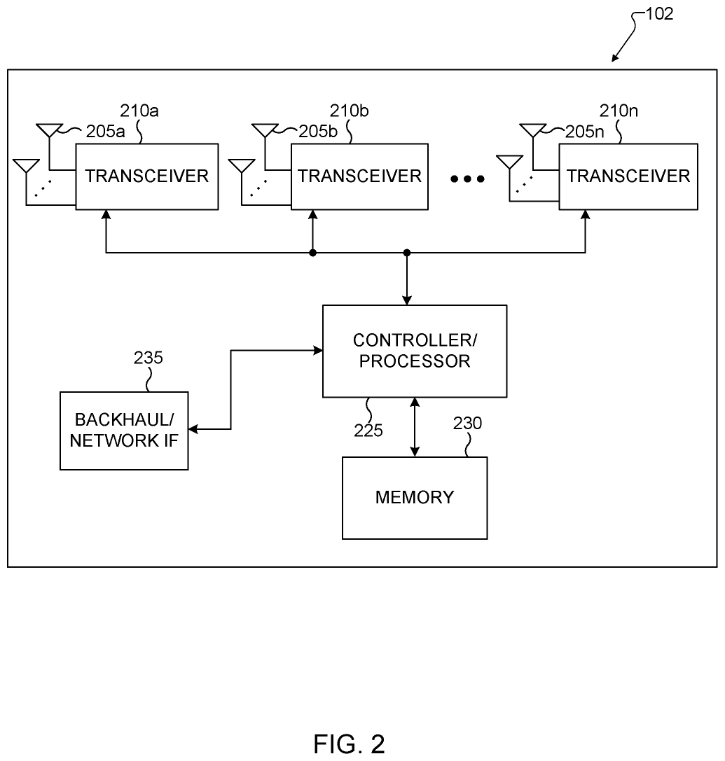

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support a traffic type based QoE maintenance for mobile devices as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

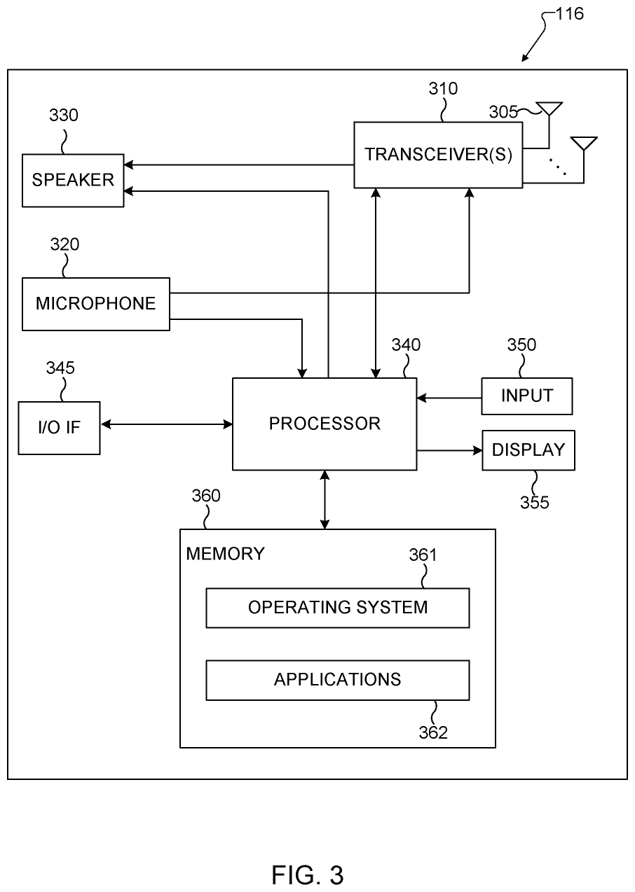

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for a traffic type based QoE maintenance for mobile devices as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

In 5G wireless networks, UEs are subjected to handovers (HO)s between different frequency bands, RATs, and cells. In addition, the UEs also transit coverage holes, where signal quality is poor. This leads to disruption in the UE's quality of experience (QoE). The issues caused by HOs and coverage holes are generally worse in a 5G network compared to previous generation wireless networks. Specifically, the HO problem is worse due to a wide variety of HOs in 5G, and the problem of coverage holes is worse due to the use of mid and high frequency bands. If the HO or coverage hole is detected retroactively—after the UE experiences a signal quality drop—then there may not be enough time to take an action to mitigate the impact on the user's QoE. As such, some prediction of signal deterioration is desirable. In addition, an appropriate action that may be taken to mitigate QoE disruption may depend on the traffic type. For example, the appropriate action may be different for real-time (RT) or non-real-time (NRT) traffic. The present disclosure describes several techniques to avoid or mitigate degradation in a user's QoE due to signal quality deterioration.

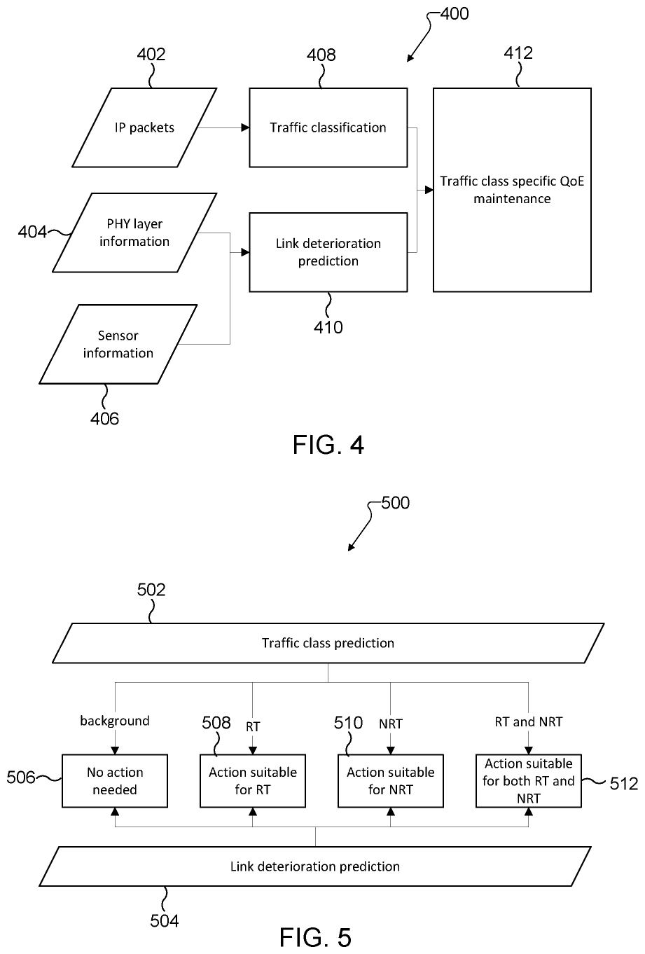

FIG. 4 illustrates an example of a QoE maintenance procedure 400 according to various embodiments of this disclosure. The QoE maintenance procedure in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a QoE maintenance procedure 400 could be used without departing from the scope of this disclosure.

In the example of FIG. 4, QoE maintenance procedure 400 begins at block 408 with traffic classification. At block 408, IP packets 402 are input to a traffic classification module. The traffic classification module predicts the current traffic class of the IP packets. The traffic classification module may consider both IP packet history and physical (PHY) layer metrics to determine the application(s) that are running on the device. Different applications can be broadly categorized into real time and non-real time traffic, e.g.,
Non-real time traffic: Streaming (e.g., YouTube, Netflix, Prime video, etc.), browsing (e.g., browsing in an app or on web browser).
Real time traffic: Audio call (e.g., WhatsApp, Messenger, Viber, etc.), video call (e.g., WhatsApp, Messenger, MS Teams, etc.), Online low-bit rate gaming (e.g., Among Us), Online high-bit rate gaming (e.g., PUBG, Call of duty, etc.).

The application classes can also be subclassified to have more than two classes. For example, the applications can have four classes: (i) real time low throughout, (ii) real time high throughput, (iii) non-real time low throughput, and (iv) non-real time high throughput. The traffic classification module takes IP packet history over a specified time window as input and predicts the applications that may be running at the UE. The traffic classification module may consider features such as packet inter-arrival time, packet size, flow type, number of active flows, traffic class of each flow, etc., to determine the application. Further, the 3GPP specified 5G QoS Identifier (5QI) values associated with a packet data unit (PDU) session may also indicate the traffic class. In one embodiment, the traffic classification module may output the predicted traffic class, or the probabilities of each class. In one embodiment, the traffic classification module can be implemented using machine learning (ML) algorithms like XGBoost or convolutional neural networks (CNN) etc. In one embodiment, the traffic classification module can be implemented based on all the IP traffic, i.e., all packets, or based on the flows, i.e., separate classification for each five-tuple (source IP address/port number, destination IP address/port number and the protocol in use, i.e., transmission control protocol (TCP)/user datagram protocol (UDP) etc.). The additional information along with inference from IP packet history may result in more accurate detection of the service type.

The specific traffic types that a traffic classifier classifies vary from one traffic classification module to another, but separating real-time (RT) traffic from non-real time (NRT) traffic is a typical objective. This objective is generally motivated by the observation that the latency tolerance of RT and NRT applications are different. In the present disclosure, it is assumed that the traffic is classified into three classes: background, RT, and NRT. The background class means that there is no active application and there is negligible traffic, whereas the RT and NRT classes are as discussed above. The NRT traffic may be further classified into: (i) NRT with frequent user interaction, and (ii) NRT without frequent user interaction.

QoE maintenance procedure 400 proceeds at block 410 with link deterioration prediction. At block 410, a link deterioration prediction module is input PHY layer information 404 (e.g., signal quality metrics such as reference signal received power (RSRP), reference signal received quality (RSRQ), signal-to-interference and noise ratio (SINR), channel quality indicator (CQI), and rank indicator (RI) etc.), and sensor information 406 (such as position, and velocity etc.), and other information (e.g., a signal map—showing signal strength as a function of position and input from the network (NW)). In one embodiment, The PHY layer information is available at a communication processor comprised by the UE. A communication processor may also be referred to as a baseband processor. The link deterioration prediction module may also be implemented at the communication processor, so that the PHY information is readily available. Further, most of the PHY layer information is shared by the device with the network (NW) for various purposes, e.g., modulation and coding scheme (MCS) determination. As such the information is shared in standard formats. As an example, the CQI and RI can be read from the channel state information reports. In case the deterioration prediction module is implemented at the application processor (AP), these reports can be shared with the AP to provide access to PHY layer information. The output of the link deterioration prediction module indicates whether the link is likely to fail over the prediction horizon or prediction period. Example values of prediction horizon could be on the order of a few seconds, e.g., 5 sec. In one embodiment, the link deterioration prediction module is based on a HO prediction module and an outage prediction module.

Finally, QoE maintenance procedure 400 proceeds at block 412. At block 412, the traffic class prediction determined at block 408 and the link deterioration prediction determined at block 410 are input to a traffic class specific QoE maintenance module. Based on the input, the traffic class specific QoE maintenance module selects some action to take—if necessary—to maintain the quality-of-experience (QoE). The action is specific to the traffic class. One example implementation of action selection is illustrated in FIG. 5, in which the prediction of the traffic class corresponds to some action.

Although FIG. 4 illustrates one example of a QoE maintenance procedure 400, various changes may be made to FIG. 4. For example, while shown as a series of steps, various steps in FIG. 4 could overlap, occur in parallel, occur in a different order, or occur any number of times.

FIG. 5 illustrates an example of traffic class specific action selection 500 according to various embodiments of this disclosure. The traffic class specific action selection in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a traffic class specific selection 500 could be used without departing from the scope of this disclosure.

In the example of FIG. 5, a traffic class specific QoE maintenance module receives a previously determined traffic class prediction 502 and previously determined link deterioration prediction 504. When there is no active application, i.e., only background traffic, no action needs to be taken (block 506), since no QoE needs to be maintained. If the predicted traffic class is RT or NRT, then some action suitable for the RT (block 508) or NRT (block 510) traffic needs to be taken. If there is mixed RT and NRT traffic, then some action suitable for both RT and NRT traffic (block 512) needs to be taken. The specific actions tied to various traffic classes may be as described within the present disclosure.

Although FIG. 5 illustrates one example of traffic class specific action selection 500, various changes may be made to FIG. 5. For example, while shown as a series of steps, various steps in FIG. 5 could overlap, occur in parallel, occur in a different order, or occur any number of times.

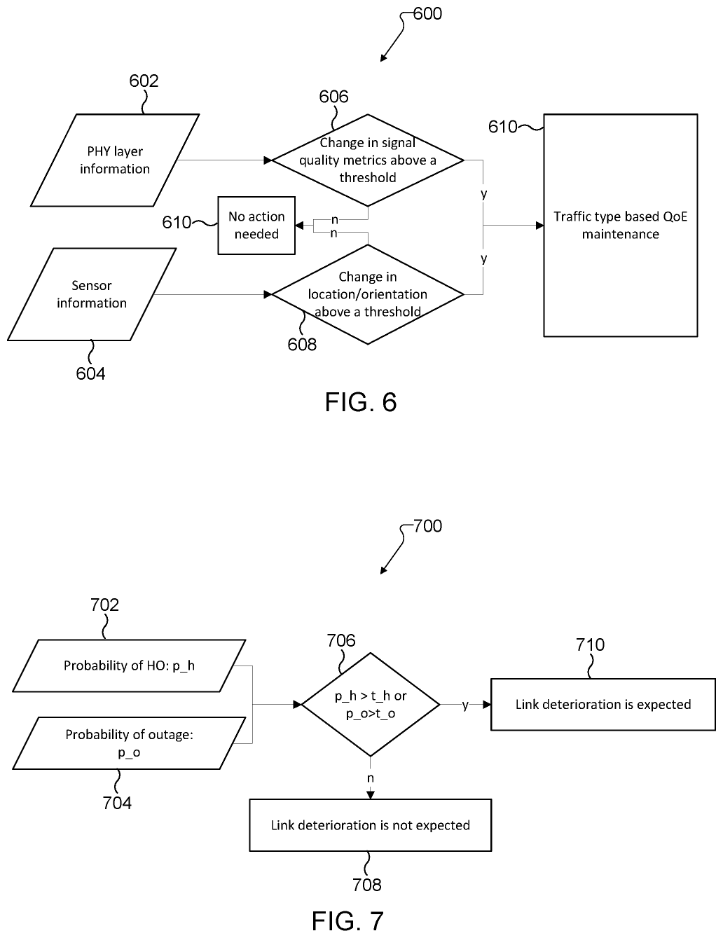

The detection of link deterioration and traffic classification can be computationally intensive, especially if done solely for QoE maintenance in mobility. Therefore, it may be advantageous to only perform the detection and classification during high mobility scenarios. In one embodiment traffic type based QoE maintenance (e.g., similar as illustrated in FIG. 4) is only used in high mobility scenarios. An example embodiment is illustrated in FIG. 6.

FIG. 6 illustrates an example procedure for selective activation of QoE maintenance 600 according to various embodiments of this disclosure. The selective activation procedure for QoE maintenance in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for selective activation of QoE maintenance 600 could be used without departing from the scope of this disclosure.

In the example of FIG. 6, PHY layer information 602 and sensor information 604 are used to detect a mobility level. The PHY layer information may include signal quality metrics such as RSRP, RSRQ, and SINR. The rate of change of these quantities can indicate rapid variations in the channel which can be a result of high mobility. The rate of change indicates the change in quantity per unit time, e.g., 1 sec. As an example, if RSRP changes more than 3 dB in one second, it can be considered a high mobility scenario. If the change is tested for a larger duration, e.g., 3 seconds, then we will have 3 values, one for each one second interval. In this case, maximum or mean of RSRP change over each second can be taken as a measure of change. One or multiple of these signal quality metrics can be tested for change. Further, the sensor information such as from a GPS, an inertial measurement unit (IMU) (which is a combination of an accelerometer, gyroscopes and/or a magnetometer), and/or NW assisted positioning can be used to infer the user's velocity. In addition, a change in orientation can also be considered a form of mobility, particularly at higher frequencies such as mmWave and THz where the nature of communication is highly directional and orientation changes can disrupt the link.

In the example of FIG. 6, when both the change in signal quality metrics (block 606) and velocity/orientation change (block 608) are above a threshold, the traffic type based QoE maintenance module is triggered (block 612). If both the change in signal quality metrics and velocity/orientation change are below the threshold, no action is needed (block 610).

Both the change in signal quality metrics and velocity/orientation change are considered because signal quality can change without any motion of the user, due to other dynamics in the channel. These dynamics may not be predictable at the UE. Further, mobility in form of velocity/orientation change itself may not indicate any deterioration in signal quality, such as the movement in the relative center of the cell, or towards the cell center. As such, both of these conditions together are a good indicator for triggering a traffic type based QoE maintenance module. In one embodiment, whenever there is a drop in the signal quality and there is movement, i.e., velocity/orientation change, the traffic type based QoE maintenance module is activated. In one embodiment, either PHY layer information or sensor information alone is used for selective activation of the traffic type based QoE maintenance module.

Although FIG. 6 illustrates one example procedure for selective activation of QoE maintenance 600, various changes may be made to FIG. 6. For example, while shown as a series of steps, various steps in FIG. 6 could overlap, occur in parallel, occur in a different order, or occur any number of times.

As previously described herein, a QoE maintenance procedure, such as QoE maintenance procedure 400 of FIG. 4 may include a link deterioration prediction, such as the link deterioration prediction at block 410. Link deterioration can happen due to several reasons. For example, link deterioration may happen due to handovers and also because of outage. In one embodiment, link deterioration prediction is based on HO prediction and outage prediction. For example, in one embodiment, a link deterioration prediction module similar as described regarding block 410 of FIG. 4 may include an HO prediction module and an outage prediction module as submodules implemented within the link deterioration prediction module. Several methods of combining the outputs of an HO prediction module and an outage prediction module are discussed herein.

In one embodiment, PHY layer information (e.g., RSRP, RSRQ, or SINR) from the serving cell and the neighboring cells is input to the HO prediction module. In another embodiment the UE speed and mobility pattern are additionally input to the HO prediction module. In one embodiment, the output of the HO prediction module is a binary indicator indicating whether a HO is likely to occur over the next T seconds. In another embodiment, the output of the HO module is a probability indicating the likelihood of handover over the next T seconds.

In one embodiment, the HO module is based on ML. In an example of such an embodiment, the HO prediction module comprises an event-based report predictor, and an HO Decision learner. The report predictor predicts the future RSRP, RSRQ, and/or SINR of the current and neighboring cells. Based on the predicted RSRP, RSRQ, and SINR, the HO prediction module predicts whether an event-based measurement report will be sent to the gNB, and if so, determines the contents of the measurement reports. The HO decision learner looks at the past measurement reports and the HO commands sent by the gNB to learn what measurements reports results in HO. Then the HO prediction module looks at the currently predicted measurement report and uses the learnt decision logic to determine whether there will be a HO.

In one embodiment, the UE location, velocity, and other information (e.g., heading and orientation) are input to the outage prediction module. In addition, a signal map is also input to the outage prediction module. The signal map is essentially a look up table that gives the signal strength information as a function of location, and other information (e.g., orientation). Orientation can be more important at 5G frequency range 2 (FR2) (i.e., 24,250-52,600 MHZ), also referred to as millimeter wave, whereas location information can be sufficient at 5G frequency range 1 (FR1) (i.e., 410-7,125 MHZ).

The signal map can be constructed in various ways. In one embodiment, the UE maintains its own signal map. Based on the history of the UE's location and observed signal strength a signal map is maintained. In another embodiment, the signal map is cooperatively developed based on multiple UE's willing to cooperate in developing a signal map. Examples of this include multiple devices inside a household that cooperate to build a signal map for the household. At a larger scale, signal map can be crowd sourced by a specific mobile phone vendor, or all cooperating UEs via some application. In one embodiment, the signal map is maintained at the NW side, and some localized version of the signal map (i.e., signal map useful over the next few seconds) is shared by the NW with the UE. There are advantages and disadvantages of all the aforementioned embodiments of generating signal maps. For instance, the UE's own signal map does not require interaction or cooperation of other UEs/NWs, but is coarse and limited to places that the UE frequents. The cooperative construction using other UEs broadens the map a bit, but requires interaction between the UEs. If the interaction is maintained between a few UEs in a household, each UE may need to maintain an updated version of the map, which may require frequent interaction between the UEs. If the interaction is maintained between a large pool of UEs through some application, then the interaction is between the server and the UEs. If the map is maintained by the NW, the map may be more accurate since every UE connected to the NW may contribute to the map. Sharing this information with UEs by the gNB, however, requires communication overhead.

In one embodiment, the output of the outage prediction module is a binary indicator indicating whether the UE will experience outage in the next T seconds. In another embodiment, the outage prediction module returns a probability that indicates, how likely the UE is to experience outage in the next T seconds. Outage may refer to a radio link failure (RLF), a condition where signal quality metrics fall below a certain threshold, failure of physical downlink control channel (PDCCH) decoding together with low signal quality metrics, failure of physical downlink shared channel (PDSCH) decoding together with low signal quality metrics, etc. Outage may also refer to a condition where the throughput supportable by the NW cannot match the demand of the currently active application.

In one embodiment, the outage prediction module is based on ML. In an example of such an embodiment, the outage prediction module is based on a four-layer architecture. The four layers are connected sequentially. There is an input layer, a long short-term memory (LSTM) layer, fully connected layer, and a support vector machine (SVM) layer. The input layer is a length N window of recent most information about e.g., RSRP/CQI values etc. The LSTM layer can learn order dependence between items in a sequence, and also the context required to make prediction in timer series forecasting problems. The LSTM uses local memory to extract temporal features from the time sequence. The fully connected layer produces one output predicted value. The SVM layer takes the predicted RSRP/CQI values from the fully connected layer and predicts outage or no outage.

As previously discussed herein, a link deterioration prediction module can be implemented the HO and outage prediction modules discussed as above. In one embodiment, both the HO and the outage prediction modules return a probability. The probability of the HO and outage is compared to a threshold to obtain a binary indicator on the HO and the outage as illustrated in FIG. 7.

FIG. 7 illustrates an example procedure for link deterioration prediction 700 according to various embodiments of this disclosure. The link deterioration prediction procedure in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for link deterioration prediction 700 could be used without departing from the scope of this disclosure.

In the Example of FIG. 7, an outage prediction module receives a probability of HO (p_h) 702 from a HO prediction module and a probability of outage (p_o) 704 from an outage prediction module. At block 706, the outage prediction module determines whether p_h is greater than a threshold for handoff (t_h), and also determines whether p_o is greater than a threshold for outage (t_o). Then a logical OR operation is performed on the two comparisons to determine whether link deterioration is expected or not. If both probabilities are not greater than their respective threshold, link deterioration is not expected (block 708). If at least one of the probabilities is greater than its respective threshold, then link deterioration is expected (block 710).

The above implementation has an advantage in that two separate thresholds for HO and outage are used by the link deterioration module. This allows the value of t_h and t_o to be selected to obtain an optimal decision. As an example, if the map of the UE is maintained only by the UE and the UE has very few measurements for the construction of the map, then more confidence can be placed in the HO prediction module. In this case the threshold t_o can be set to a large value, i.e., close to 1. If the UE is in a location, which the UE often frequents, the confidence in the UE map can be high. In contrast, if the outage prediction is based on the NW's shared map, and the UE goes into a region that it does not frequent, high confidence can be placed in the NW's shared map. In this scenario, the UE's HO prediction module, however, may be inaccurate, particularly if the HO logic is geography specific and the UE has not been in the region before. In this case, the threshold for the HO module can be set to a high value, i.e., close to 1, whereas the threshold for the outage module can be set to a low to moderate value, e.g., 0.3 to 0.7.

Although FIG. 7 illustrates one example procedure for link deterioration prediction 700, various changes may be made to FIG. 7. For example, while shown as a series of steps, various steps in FIG. 7 could overlap, occur in parallel, occur in a different order, or occur any number of times.

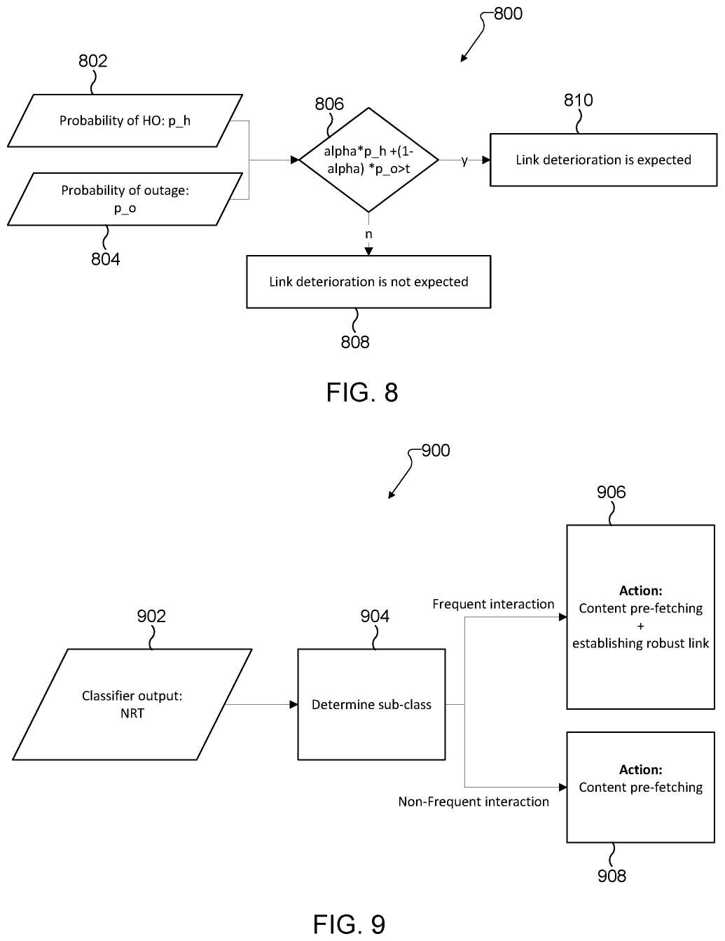

In another embodiment, the link deterioration decision is based on comparing the weighted average of the HO probability p_h and the outage probability p_o as illustrated FIG. 8.

FIG. 8 illustrates an example procedure for link deterioration prediction 800 according to various embodiments of this disclosure. The link deterioration prediction procedure in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for link deterioration prediction 800 could be used without departing from the scope of this disclosure.

In the Example of FIG. 8, an outage prediction module receives a probability of HO (p_h) 802 from a HO prediction module and a probability of outage (p_o) 804 from an outage prediction module. At block 806, the outage prediction module determines whether the weighted average of p_h and p_o is greater than a threshold t. If the weighted average is not greater than t, link deterioration is not expected (block 808). If the weighted average is not greater than t, then link deterioration is expected (block 810). The weight is α∈[0,1].

The value of alpha=0.5 implies equal preference/weight for the HO probability and outage probability, whereas alpha>0.5 implies higher weight on p_h and alpha<0.5 implies lower weight on p_h. In essence this achieves a similar result as the embodiment of FIG. 7, but with a slight difference. In the example of FIG. 8, whenever the value of alpha changes, the weight for one HO and outage increases and the weight for the other one decreases. In contrast, in the example of FIG. 7, the thresholds for both p_h and p_o are independent and varying one does not impact the other.

Although FIG. 8 illustrates one example procedure for link deterioration prediction 800, various changes may be made to FIG. 8. For example, while shown as a series of steps, various steps in FIG. 8 could overlap, occur in parallel, occur in a different order, or occur any number of times.

In one embodiment, the HO and outage prediction modules themselves return binary Y/N indicators for HO and outage over the next T seconds. In this embodiment, the link deterioration prediction module is simply the OR operation between the two outputs. That is, the link deterioration is considered likely if either the HO or the outage is likely.

In another embodiment, either an HO prediction module or an outage prediction module is used standalone as a link deterioration prediction module. For example, this embodiment may be used in the case where only one of the two modules is implemented at the device.

As previously described herein, a QoE maintenance procedure, such as QoE maintenance procedure 400 of FIG. 4, may include selection of an action by a traffic class specific QoE maintenance module, such as in the traffic class specific QoE maintenance at block 410. In one embodiment, if the traffic class is NRT, the action may include content pre-fetching. In another embodiment, the traffic class is NRT, the action may include switching to a robust link. In one embodiment, if the traffic class is NRT, the traffic is further classified into a one of two subclasses depending on the level of interaction with the device before selecting the action as illustrated in FIG. 9.

FIG. 9 illustrates an example of traffic class specific action selection 900 according to various embodiments of this disclosure. The traffic class specific action selection in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a traffic class specific selection 900 could be used without departing from the scope of this disclosure.

In the example of FIG. 9, a traffic class specific QoE maintenance module receives a previously determined traffic class prediction 902 indicating NRT traffic. At block 904, the QoE maintenance module determines whether a sub-class of the NRT traffic is predicted as one of (i) frequent interaction, in which the user frequently interacts with the device, and (ii) non-frequent interaction, in which the user does not frequently interact with the device. If the sub-class is determined to be frequent interaction, the QoE maintenance module initiates content pre-fetching and establishes a robust link (block 906). If the sub-class is determined to be non-frequent interaction, the QoE maintenance module only initiates content pre-fetching.

In embodiment, the output of the traffic classifier (e.g., based on IP packet data) provides the sub-class level prediction. Note, however, that the sub-class level prediction can be determined from simple detection rules for the UL IP data, a sub-classifier of the traffic can be a separate module following traffic classifier, etc. In one embodiment, the sub-class level prediction is determined by directly observing user interaction with the input modules of the device, e.g., the touchscreen.

Sub-classification is performed because the appropriate actions for the two subclasses are different. Specifically, for the applications—e.g., video streaming—in which the user may play a video and may not interact with the phone for a while, content pre-fetching can be an appropriate action. Note here that there is no guarantee that the user will not interact with the streaming application, since the user may choose e.g., to move a video forward. The classification of streaming as non-interactive only indicates that interaction is less likely. Another example is a large file download, in which the user may not interact with the device after initiating the file download. Content pre-fetching implies that while the channel conditions are supporting the action, content is fetched at the UE so that the UE can transmit the link-deterioration phase without having QoE issues, e.g., video stall. In contrast, if the user is interacting with the device, e.g., while browsing or scrolling through social media, it is not entirely clear what content the user will view next. For social media, it may happen that the user continues to scroll down. In this case, content pre-fetching can help. In contrast, however, if the user decides to tap on a certain link, content pre-fetching could be challenging due to large and varying possibilities. As such, for the NRT applications in which the user continuously interacts with the device, the most likely content is pre-fetched, but also a robust link is established in case the user requests content that is not pre-fetched.

Although FIG. 9 illustrates one example of traffic class specific action selection 900, various changes may be made to FIG. 9. For example, while shown as a series of steps, various steps in FIG. 9 could overlap, occur in parallel, occur in a different order, or occur any number of times.

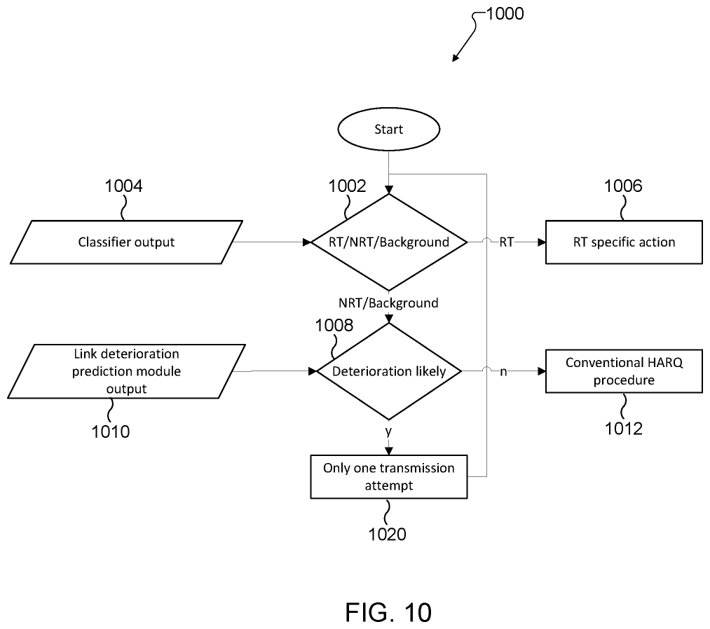

Hybrid automatic repeat request (HARQ) is used in cellular communications to ensure that the UE data is received at the gNB. When the UE sends the data, the gNB receives the data and sends an ACK to the UE. In case, the gNB fails to receive the data from the UE, it instead sends NACK. If the UE receives a NACK, it re-transmits the data. If the prediction of the link deterioration module is that the link quality is poor, re-transmission attempts are also likely to fail. These retransmission attempts do not necessarily result in improved QoE—in terms of accessing more content—but have an impact on UE's battery life. The battery life of the UE may also impact the QoE of the user. Therefore, it may be advantageous for traffic class specific action selection to improve battery life. In one embodiment, the selected action is taken to enhance the UE battery life as illustrated in FIG. 10.

FIG. 10 illustrates an example of traffic class specific action selection 1000 according to various embodiments of this disclosure. The traffic class specific action selection in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a traffic class specific selection 1000 could be used without departing from the scope of this disclosure.

In the example of FIG. 10, at block 1002 a traffic class specific QoE maintenance module receives a previously determined traffic class prediction 1004, and determines whether the traffic class is RT, NRT, or background. If the traffic prediction is RT, the QoE maintenance module selects an RT specific action at block 1006. Otherwise, if the traffic class is NRT or background, at block 1008 the QoE maintenance module determines whether deterioration is likely based on link deterioration prediction 1010. If deterioration is not predicted to be likely, the QoE maintenance module allows the UE to perform a conventional HARQ procedure. Otherwise, if deterioration is predicted to be likely, the QoE maintenance module allows the UE to perform only one transmission attempt re-transmissions are not attempted to save battery life.

Although FIG. 10 illustrates one example of traffic class specific action selection 1000, various changes may be made to FIG. 10. For example, while shown as a series of steps, various steps in FIG. 10 could overlap, occur in parallel, occur in a different order, or occur any number of times.

For real-time traffic, latency has a high impact on QoE, and the impact of a poor link on latency should be mitigated. The NW uses several criteria to connect the UE to a specific band/radio access technology (RAT). For example, in presence of a high speed 5G the UE may be connected to the 5G over LTE. LTE, however, may be more reliable than the 5G in mobility. As an example, consider that most of the 5G deployment today is non-stand-alone (NSA) and the footprint of 5G stand-alone (SA) is rather limited. There is a complex series of mobility events in NSA, e.g., secondary cell group (SCG) addition (4G->5G) HO, SCG release (5G->4G) HO, SCG change (5G->5G) HO—which may include SCG release, 4G->4G HO, and SCG addition. All these mobility events mean that 5G service is more frequently interrupted. Because of this, for RT applications the UE may prefer to use LTE. To this end, note that in NSA, VoLTE is used for voice whereas data is served by NR. Further, since SA is not yet mature, the NW may not support VoNR and one 5G voice solution is for the NW to perform a HO to the LTE NW when the UE initiates a HO (this solution is called evolved packet system (EPS) fall back). Further, within 5G, the high speeds in 5G are tied to mid-band (1 GHz-6 GHz) and high-band (24-40 GHz). Due to the physics of propagation, these bands, however, provide shorter coverage and are likely to result in more coverage holes. As such, while using real-time traffic, the UE may prefer to use 5G on low bands or LTE.

As previously described herein, a QoE maintenance procedure, such as QoE maintenance procedure 400 of FIG. 4, may include selection of an action by a traffic class specific QoE maintenance module, such as in the traffic class specific QoE maintenance at block 410. In one embodiment, if the traffic class is RT, the action may include switching to a robust band. In one embodiment, if the traffic class is RT, the action may include switching to a different RAT.

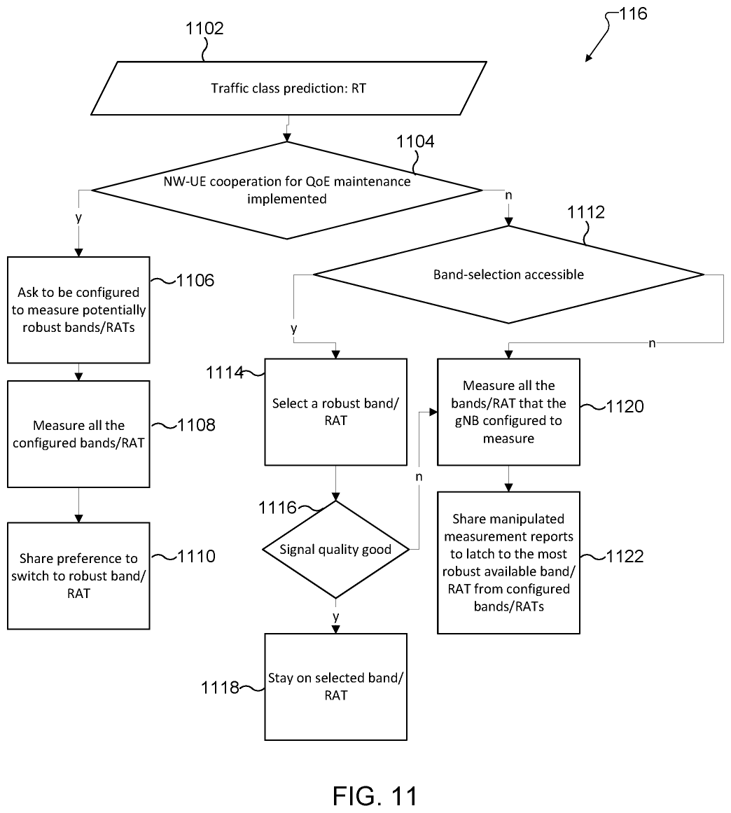

In one embodiment, as soon as the device detects real-time traffic, the device initiates a procedure to switch RAT (5G, LTE) or band (among various frequency bands on a given RAT) to gain more robustness/reliability. The procedure is initiated as soon as the device detects real-time traffic instead of waiting for the prediction of link deterioration because: (i) the prediction from the link deterioration module may not leave enough time for initiation and switching to a different RAT/band, and (ii) even if there is sufficient time, switching the RAT/band may still lead to some interruption time—though less than the case when no proactive action is taken. One possible solution is to have an implementation in which the UE indicates its preference on the RAT/band to the NW—via some signaling mechanism developed among cooperating NW and UE vendors. Second, note that the UE can turn off certain bands/RATs via band/RAT-selection mode that is often made available even to the users. Accessing these menus/options in an automated manner is another possibility for the UE to force latch to a certain band/RAT. To implement this method, the UE needs to know which bands/RATs are robust. In one embodiment, this knowledge is based on general understanding, e.g., LTE is likely to be more robust than 5G, and low frequency bands are likely to be more robust than mid or high bands. In another embodiment, the UE tracks the signal quality metrics, i.e., RSRP/RSRQ/SINR etc., on each band/RAT. In addition, the UE tracks the amount of time spent on each band/RAT before link deterioration. The time spent on each band/RAT before link deterioration should correlate with the robustness of the band/RAT. During online operation, the UE consults its own measurements and historical data to determine which RAT and band is likely to be robust. The historical measurements can also be made location specific, so the UE knows which band/RAT is more likely to be robust at a given location. The risk of this methodology is that the band/RAT that is typically robust may not be available at a given time. If this the case, then the UE needs to measure all the bands/RATs configured by the gNB and select the most robust among the measured bands/RATs. The third possibility is to manipulate the signal measurement reports to get latched to a desired band/RAT. Note, however, that it is the gNB that configures the UE to perform intra-frequency, inter-frequency, and inter-RAT measurements. As such, the UE will only measure for the bands/RATs that the gNB configures. All in all, the solution based on cooperation between the UE and the NW is least risky. The manipulation of the UE report is a UE side solution, which allows the UE to influence the RAT/band selection, but there can be limited bands/RATs configured by the gNB for the UE to measure. Finally, the UE doing the band/RAT selection using automated menus provides a reliable way to latch to a band, but a robust band may not be available which could lead to a lost connection, at least temporarily. The above considerations are taken into account in the procedure illustrated in FIG. 11.

FIG. 11 illustrates an example of traffic class specific action selection 1100 according to various embodiments of this disclosure. The traffic class specific action selection in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a traffic class specific selection 1100 could be used without departing from the scope of this disclosure.

In the example of FIG. 11, a traffic class specific QoE maintenance module receives a previously determined traffic class prediction 1102 indicating RT traffic. At block 1104, the QoE maintenance module determines whether NW-UE cooperation for QoE maintenance is implemented. If NW-UE cooperation for QoE maintenance is implemented, the action selection procedure continues at block 1106. Otherwise, if NW-UE cooperation for QoE maintenance is not implemented the action selection procedure continues at block 1112.

At block 1106, the UE asks the NW to be configured to measure potentially robust bands/RATs. At block 1108, the UE measures the configured bands/RATs. At block 1100, the UE shares its preference to the NW to switch to a robust band/RAT determined from the measurements of block 1108.

At block 1112, the UE determines whether band-selection is accessible. If band selection is accessible, the action selection procedure continues at block 1114. Otherwise, if band selection is not accessible, the action selection procedure continues at block 1120.

At block 1114, the UE selects a robust band and/or RAT. At block 1116, the UE determines if the selected band and/or RAT has adequate signal quality. If not, the action selection procedure continues at block 1120. Otherwise, the UE stays on the selected band and/or RAT at block 1118.

At block 1120, the UE measures all of the available bands/RATs that the gNB has configured the UE to measure. At block 1122, the UE shares manipulated measurement reports with the gNB as an attempt to latch the most robust available band and/or RAT from among the configured bands/RATs.

Although FIG. 11 illustrates one example of traffic class specific action selection 1100, various changes may be made to FIG. 11. For example, while shown as a series of steps, various steps in FIG. 11 could overlap, occur in parallel, occur in a different order, or occur any number of times.

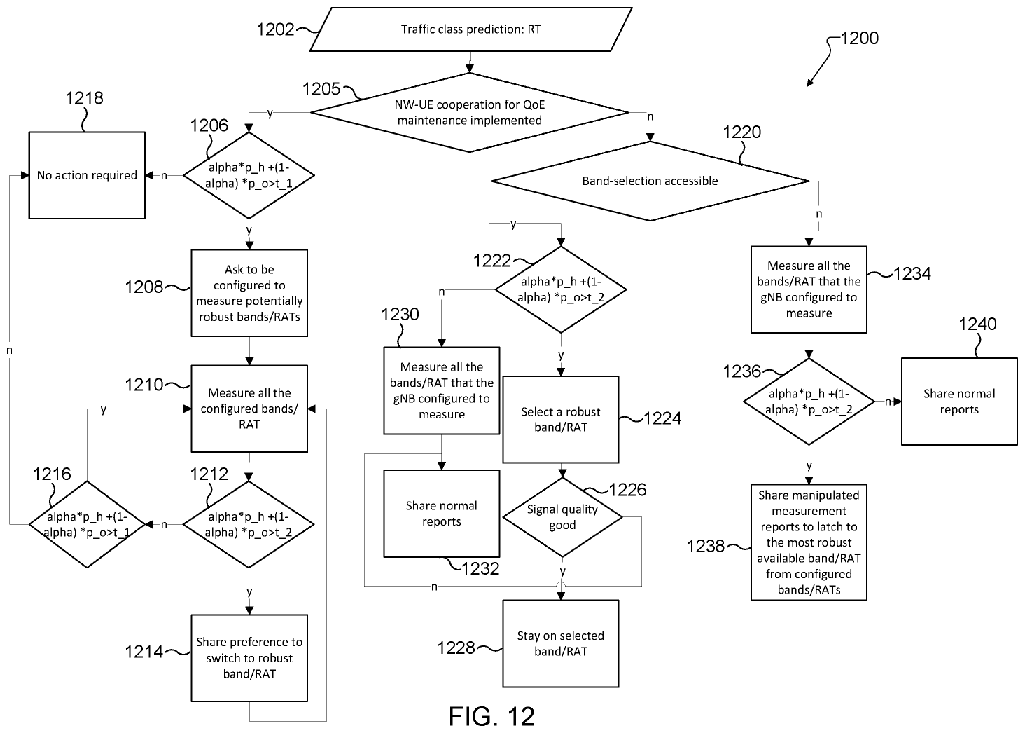

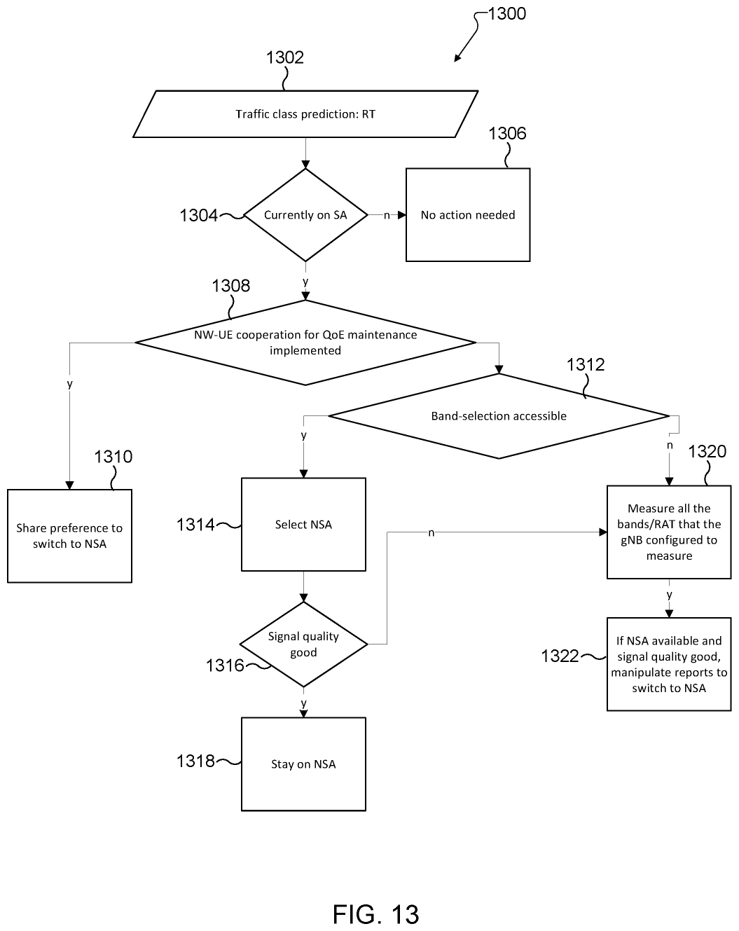

In one embodiment, the UE considers the probabilities of the link deterioration in initiating the measurements for different bands/RATs and switching. As an example, when alpha*p_h+(1−alpha)*p_o>t_1, and UE and NW cooperate, the UE requests to be configured to measure robust bands/RATs. Only when alpha*p_h+(1−alpha)*p_o>t_2, the UE requests to be switched to one of those bands. For automated band/RAT selection at UE, the UE only does the band/RAT selection when alpha*p_h+(1−alpha)*p_o>t_2, otherwise the UE follows the normal procedure of measurements and reporting. For report manipulation, the UE only shares manipulated reports when alpha*p_h+(1−alpha)*p_o>t_2, otherwise the UE follows the normal reporting procedure. The thresholds t_1 and t_2 follow the relationship t_1<=t_2. Conceptually, when the probability of link deterioration reaches a moderate level, the measurements on robust bands are initiated, and when it reaches high level, band/RAT is switched. Example values, of t_1 are 0.5-0.6, and t_2 are 0.7-0.8. An example of this embodiment is illustrated in FIG. 12.

FIG. 12 illustrates an example of traffic class specific action selection 1200 according to various embodiments of this disclosure. The traffic class specific action selection in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a traffic class specific selection 1200 could be used without departing from the scope of this disclosure.

In the example of FIG. 12, a traffic class specific QoE maintenance module receives a previously determined traffic class prediction 1202 indicating RT traffic. At block 1204, the QoE maintenance module determines whether NW-UE cooperation for QoE maintenance is implemented. If NW-UE cooperation for QoE maintenance is implemented, the action selection procedure continues at block 1206. Otherwise, if NW-UE cooperation for QoE maintenance is not implemented the action selection procedure continues at block 1220.

At block 1206, the UE determines whether the weighted average of p_h and p_o is greater than a threshold t_1, similar as described regarding block 806 of FIG. 8. If threshold t_1 is exceeded, then the action selection procedure continues at block 1208. Otherwise, no action is required (block 1218). At block 1208 the UE asks the NW to be configured to measure potentially robust bands/RATs. At block 1210, the UE measures the configured bands/RATs.

At block 1212, the UE determines whether the weighted average of p_h and p_o is greater than a threshold t_2, similar as described regarding block 806 of FIG. 8. If threshold t_2 is exceeded, then the action selection procedure continues at block 1214. Otherwise, at block 1216, the UE the UE determines whether the weighted average of p_h and p_o is greater than the threshold t_1, similar as described regarding block 806 of FIG. 8. If threshold t_1 is exceeded, then the action selection procedure returns to block 1210. Otherwise, no action is required (block 1218). At block 1214, the UE the UE shares its preference to the NW to switch to a robust band/RAT determined from the measurements of block 1210. Then the action selection procedure returns to block 1210.

At block 1220, the UE determines whether band-selection is accessible. If band selection is accessible, the action selection procedure continues at block 1222. Otherwise, if band selection is not accessible, the action selection procedure continues at block 1234.

At block 1222, the UE determines whether the weighted average of p_h and p_o is greater than a threshold t_2, similar as described regarding block 806 of FIG. 8. If threshold t_2 is exceeded, then the action selection procedure continues at block 1224. Otherwise, the action selection procedure continues at block 1230. At block 1224, the UE selects a robust band and/or RAT. At block 1266, the UE determines if the selected band and/or RAT has adequate signal quality. If not, the action selection procedure continues at block 1232. Otherwise, the UE stays on the selected band and/or RAT at block 1228. At block 1230, the UE measures all of the available bands/RATs that the gNB has configured the UE to measure. At block 1232, the UE shares normal measurement reports with the gNB.

At block 1234, the UE measures all of the available bands/RATs that the gNB has configured the UE to measure. At block 1236, the UE determines whether the weighted average of p_h and p_o is greater than a threshold t_2, similar as described regarding block 806 of FIG. 8. If threshold t_2 is exceeded, then the action selection procedure continues at block 1224. Otherwise, the action selection procedure continues at block 1230. At block 1238, the UE shares manipulated measurement reports with the gNB as an attempt to latch the most robust available band and/or RAT from among the configured bands/RATs. At block 1240, the UE shares normal measurement reports with the gNB.

Although FIG. 12 illustrates one example of traffic class specific action selection 1200, various changes may be made to FIG. 12. For example, while shown as a series of steps, various steps in FIG. 12 could overlap, occur in parallel, occur in a different order, or occur any number of times.

In yet another embodiment, if the UE is currently on 5G standalone (SA), as soon as RT traffic is detected, the UE initiates a procedure to switch to 5G non-standalone (NSA). This is helpful when the NSA implementation is E-UTRAN NR dual connectivity (ENDC), that enables the UE to simultaneously connect to the LTE and 5G NR networks. This way the UE implicitly maintains a backup LTE link. With ENDC, the UE traffic will automatically go over LTE in case the 5G NR link deteriorates. The switching from SA to NSA can be achieved using the same three methods (UE-NW cooperation, automating the RAT selection, and report manipulation) as discussed above and illustrated in FIG. 13. This strategy is also motivated by the observation that the footprint of current 5G SA implementation is limited and most of the 5G implementation today is NSA. As such, in mobility disruption is more likely on SA.

FIG. 13 illustrates an example of traffic class specific action selection 1300 according to various embodiments of this disclosure. The traffic class specific action selection in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a traffic class specific selection 1300 could be used without departing from the scope of this disclosure.

In the example of FIG. 13, a traffic class specific QoE maintenance module receives a previously determined traffic class prediction 1302 indicating RT traffic. At block 1304, the QoE maintenance module determines whether the UE is currently on a 5G SA network. If the UE is not on a 5G SA network, no action is needed (block 1306). Otherwise, the action selection procedure continues at 1308. At block 1308, the QoE maintenance module determines whether NW-UE cooperation for QoE maintenance is implemented. If NW-UE cooperation for QoE maintenance is implemented, the action selection procedure continues at block 1310. Otherwise, if NW-UE cooperation for QoE maintenance is not implemented the action selection procedure continues at block 1312.

At block 1310, the UE shares a preference with the NW to switch to from SA to NSA. At block 1312, the UE determines whether band-selection is accessible. If band selection is accessible, the action selection procedure continues at block 1314. Otherwise, if band selection is not accessible, the action selection procedure continues at block 1320.

At block 1314, the UE selects NSA. At block 1316, the UE determines if NSA has adequate signal quality. If not, the action selection procedure continues at block 1320. Otherwise, the UE stays on NSA at block 1318.

At block 1320, the UE measures all the bands/RATs that the gNB has configured the UE to measure. At block 1322, if NSA is available and has adequate signal quality, the UE shares manipulated measurement reports with the gNB as an attempt to switch to NSA.

Although FIG. 13 illustrates one example of traffic class specific action selection 1300, various changes may be made to FIG. 13. For example, while shown as a series of steps, various steps in FIG. 13 could overlap, occur in parallel, occur in a different order, or occur any number of times.

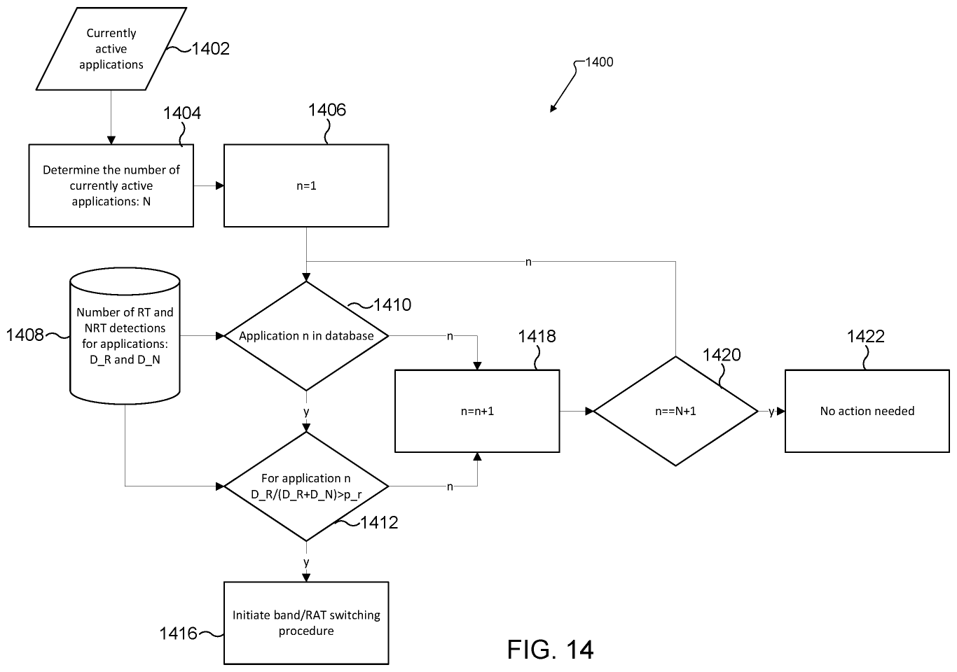

In aforementioned embodiments, once it is detected that the traffic is RT, switching of band/RAT is initiated. This, however, is a reactive approach. Since the RT traffic has already started, this could still lead to some disruption at the beginning. In another embodiment, it can be predicted that RT traffic is likely in the future for proactive switching of band/RAT. This prediction may be referred to as a future traffic prediction. An example procedure for proactive band/RAT switching is illustrated in FIG. 14.

FIG. 14 illustrates an example procedure for proactive QoE maintenance 1400 according to various embodiments of this disclosure. The proactive QoE maintenance procedure in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a procedure for proactive QoE maintenance 1400 could be used without departing from the scope of this disclosure.

In the example of FIG. 14, the procedure begins at block 1404. At block 1404, currently active applications 1402 are fetched. The currently active applications 1402 can be fetched directly from the operating system. In parallel a database 1408 is maintained which contains the probability of RT/NRT traffic from each application. This database can be developed on the go based on observations, e.g., whenever a new application is reported from the operating system, the subsequent detections of the traffic classifier can be logged and the number of RT and NRT predictions are stored. In future, whenever the same application is used again the number of RT and NRT predictions—called D_R and D_NRT are updated. This way the fraction, i.e., D_R/(D_R+D_N) can provide the probability of an application having RT traffic. For each active application determined in block 1404, the UE checks to see if the application has a prediction stored in database 1408. If the databased has no prediction for that application, the procedure flows to block 1422 and no action is taken. If the application does have a prediction stored in database 1408, at block 1412, it is determined whether the current application is likely to generate RT traffic. This is based on comparing the fraction D_R/(D_R+D_N) with a threshold probability p_r. If the application does not exceed the threshold, the procedure flows to block 1422 and no action is taken. Otherwise, If any of the currently active applications satisfy this threshold, then at block 1416 the procedure for band/RAT switching is initiated. As an example, consider the WhatsApp application. Depending on the user, the application may be primarily used for audio/video calls. In this case, database will maintain that the application is likely an RT application. As such, as soon as the user will open the WhatsApp application, the band/RAT switching will be initiated. This switching can be completed before the user makes a call and as such will not disrupt the call.

In another embodiment, the currently active applications are not fetched from the operating system directly, but rather through some tool for TCP monitoring. One example is netstat that gives the process ID for every five tuples (TCP/IP protocol, TX and RX IPs, and ports). With this kind of information, the currently active process IDs are monitored. Specifically, process IDs replace the role of applications in FIG. 14. The database is also maintained for process IDs instead of applications.

Finally, in one embodiment, for mixed RT and NRT traffic, the procedures previously described for RT traffic are applied. This is because the procedures described for the NRT traffic, i.e., content pre-fetching cannot maintain the QoE for the RT traffic, whereas the procedures described for the NRT traffic—based on RAT/band switching can help maintain the QoE for the NRT traffic.

Although FIG. 14 illustrates one example procedure for proactive QoE maintenance 1400, various changes may be made to FIG. 14. For example, while shown as a series of steps, various steps in FIG. 14 could overlap, occur in parallel, occur in a different order, or occur any number of times.

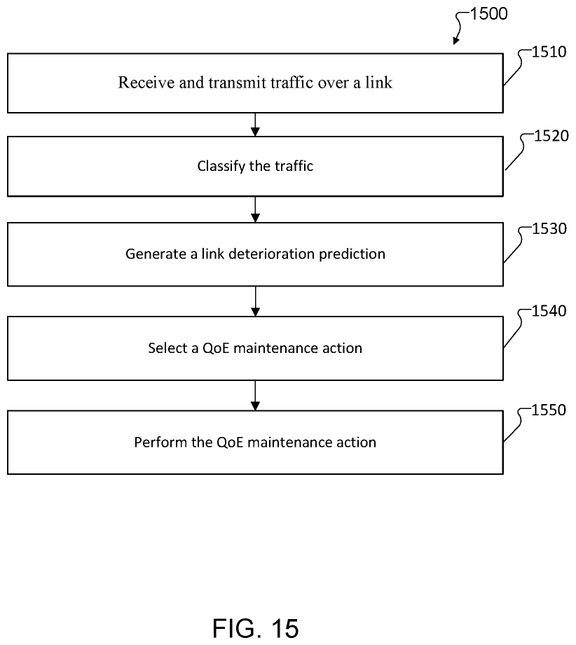

FIG. 15 illustrates a method 1500 for traffic type based QoE maintenance according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method 1500 for traffic type based QoE maintenance may be used without departing from the scope of this disclosure.

As illustrated in FIG. 15, the method 1500 begins at step 1510. At step 1510, a UE receives and transmits traffic over a link with a wireless network. At step 1520, the UE classifies the traffic. The traffic is classified into at least one of RT traffic or NRT traffic. At step 1530, the UE generates a link deterioration prediction. At step 1540, the UE selects a QoE maintenance action. The QoE maintenance action is selected based on the link deterioration prediction and the traffic class. Finally, at step 1550, the UE performs the QoE maintenance action.

Although FIG. 15 illustrates one example of a method 1500 for traffic type based QoE maintenance, various changes may be made to FIG. 15. For example, while shown as a series of steps, various steps in FIG. 15 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive and transmit traffic over a link with a wireless network; and
a processor operably coupled to the transceiver, the processor configured to:
classify the traffic into at least one of real time (RT) traffic or non-real-time (NRT) traffic;
generate a link deterioration prediction;
select, based on the link deterioration prediction and the traffic class, a quality of experience (QoE) maintenance action; and
perform the QoE maintenance action.

2. The UE of claim 1, wherein the processor is further configured to:
receive physical (PHY) layer information related to the link with the wireless network;
receive sensor information from at least one sensor comprised by the UE;
determine whether the PHY layer information indicates that a change in at least one signal quality metric exceeds a first threshold; and
determine whether the sensor information indicates that a change in at least one of a location or orientation of the UE exceeds a second threshold,
wherein the classification of the traffic, the generation of the link deterioration prediction, and the selection of the QoE maintenance action are performed based on an indication of exceeding the first threshold or an indication of exceeding the second threshold.

3. The UE of claim 1, wherein the processor is further configured to:
determine a handoff (HO) probability;
determine an outage probability;
determine whether the HO probability exceeds a first threshold; and
determine whether the outage probability exceeds a second threshold,
wherein the link deterioration prediction is generated based on the HO probability exceeding the first threshold or the outage probability exceeding the second threshold.

4. The UE of claim 1, wherein the processor is further configured to:
determine a handoff (HO) probability;
determine an outage probability; and
determine a relationship between the HO probability and the outage probability,
wherein the link deterioration prediction is generated based on the relationship between the HO probability and the outage probability.

5. The UE of claim 1, wherein:
the traffic is classified as NRT traffic,
the processor is further configured to determine a sub-class of the NRT traffic,
if the sub-class of the NRT traffic is determined as frequent interaction, the selected QoE maintenance action comprises content pre-fetching and establishing a robust link, and
if the sub-class of the NRT traffic is determined as non-frequent interaction, the selected QoE maintenance action comprises content pre-fetching.

6. The UE of claim 1, wherein:
the link deterioration prediction is poor link quality; and
based on the link deterioration prediction being poor link quality, the selected QoE maintenance action comprises refraining from performing hybrid automatic repeat request (HARQ) retransmissions.

7. The UE of claim 1, wherein:
the traffic is classified as RT traffic; and
to select the QoE maintenance action, the processor is further configured to:
measure a plurality of available bands and a plurality of available radio access technologies (RATs); and
at least one of:
switch to a robust band;
switch to a different RAT; and
switch from 5G standalone (SA) to 5G non-standalone (NSA).

8. The UE of claim 7, wherein the processor is further configured to:
determine that network-UE (NW-UE) cooperation for QoE maintenance is not implemented;
determine, based on NW-UE cooperation for QoE maintenance not being implemented, whether band-selection is accessible; and
if band-selection is not accessible:
generate a manipulated measurement report based on the measuring; and
share the manipulated measurement report with the wireless network.

9. The UE of claim 7, wherein the processor is further configured to:
determine a handoff (HO) probability;
determine an outage probability; and
determine a relationship between the HO probability and the outage probability,
wherein at least one of switching to the robust band and switching to the different RAT is based on the relationship between the HO probability and the outage probability.

10. The UE of claim 1, wherein:
to classify the traffic, the processor is further configured to generate a future traffic prediction; and
the processor is further configured to, if the future traffic prediction is real time (RT), switch to at least one of a robust band and a different RAT.

11. A method of operating a user equipment (UE), the method comprising:
receiving and transmitting traffic over a link with a wireless network;
classifying the traffic into at least one of real time (RT) traffic or non-real-time (NRT) traffic;
generating a link deterioration prediction;
selecting, based on the link deterioration prediction and the traffic class, a quality of experience (QoE) maintenance action; and
performing the QoE maintenance action.

12. The method of claim 11, further comprising:
receiving physical (PHY) layer information related to the link with the wireless network;
receiving sensor information from at least one sensor comprised by the UE;
determining whether the PHY layer information indicates that a change in at least one signal quality metric exceeds a first threshold; and
determining whether the sensor information indicates that a change in at least one of a location or orientation of the UE exceeds a second threshold,
wherein the classification of the traffic, the generation of the link deterioration prediction, and the selection of the QoE maintenance action are performed based on an indication of exceeding the first threshold or an indication of exceeding the second threshold.

13. The method of claim 11, further comprising:
determining a handoff (HO) probability;
determining an outage probability;
determining whether the HO probability exceeds a first threshold; and
determining whether the outage probability exceeds a second threshold,
wherein the link deterioration prediction is generated based on the HO probability exceeding the first threshold or the outage probability exceeding the second threshold.

14. The method of claim 11, further comprising:
determining a handoff (HO) probability;
determining an outage probability; and
determining a relationship between the handoff (HO) probability and the outage probability,
wherein the link deterioration prediction is generated based on the relationship between the HO probability and the outage probability.

15. The method of claim 11, wherein:
the traffic is classified as NRT traffic,
the method further comprises determining a sub-class of the NRT traffic,
if the sub-class of the NRT traffic is determined as frequent interaction, the selected QoE maintenance action comprises content pre-fetching and establishing a robust link, and
if the sub-class of the NRT traffic is determined as non-frequent interaction, the selected QoE maintenance action comprises content pre-fetching.

16. The method of claim 11, wherein:
the link deterioration prediction is poor link quality; and
based on the link deterioration prediction being poor link quality, the selected QoE maintenance action comprises refraining from performing hybrid automatic repeat request (HARQ) retransmissions.

17. The method of claim 11, wherein:
the traffic is classified as RT traffic; and
selecting the QoE maintenance action comprises:
measuring a plurality of available bands and a plurality of available radio access technologies (RATs); and
at least one of:
switching to a robust band;
switching to a different RAT; and
switching from 5G standalone (SA) to 5G non-standalone (NSA).

18. The method of claim 17, further comprising:
determining that network-UE (NW-UE) cooperation for QoE maintenance is not implemented;
determining, based on NW-UE cooperation for QoE maintenance not being implemented, whether band-selection is accessible; and
if band-selection is not accessible:
generating a manipulated measurement report based on the measuring; and
sharing the manipulated measurement report with the wireless network.

19. The method of claim 17, further comprising:
determining a handoff (HO) probability;
determining an outage probability; and
determining a relationship between the HO probability and the outage probability,
wherein at least one of switching to the robust band and switching to the different RAT is based on the relationship between the HO probability and the outage probability.

20. The method of claim 11, wherein:
classifying the traffic comprises generating a future traffic prediction; and
the method further includes:
if the future traffic prediction is real time (RT), switching to at least one of a robust band and a different RAT.
